(19) United States
(12) Patent Application Publication
(10) Pub. No.: US 2014/0357469 A1
(43) Pub. Date: Dec. 4, 2014

(54) METHOD FOR PRODUCING MINERAL WOOL

(71) Applicant: SAINT-GOBAIN ISOVER, Courbevoie (FR)

(72) Inventors: Sebastien Beaufils, Cernoy (FR); Richard Clatot, Fleurines (FR)

(73) Assignee: SAINT-GOBAIN ISOVER, Courbevoie (FR)

(21) Appl. No.: 14/374,655

(22) PCT Filed: Jan. 25, 2013
(86) PCT No.: PCT/FR2013/050152

§ 371 Date: Jul. 25, 2014

(30) Foreign Application Priority Data
Jan. 27, 2012 (FR) 12 50796

(51) Int. Cl. C03B 5/43; C03B 37/04; C03C 13/06; C03B 5/03

(52) U.S. Cl. CPC C03B 5/43; C03B 5/03; C03B 37/04; C03C 13/06
USPC 501/36; 373/33; 65/460

(57) ABSTRACT

A process for the manufacture of mineral wool can involve, first, a melting stage which makes it possible to obtain a molten glass. The chemical composition of the molten glass comprises the following constituents, in a content by weight, within the following limits: SiO₂, 39-55%; Al₂O₃, 16-27%; CaO, 3-35%; MgO, 0-5%; Na₂O+K₂O, 9-17%; Fe₂O₃, 0-15%; and B₂O₃, 0-8%. The melting stage is carried out by electric melting in a furnace that has a tank made of refractory blocks and at least two electrodes immersed in the molten glass. At least one of the refractory blocks, in contact with the molten glass, is made of a material having at least 60% by weight of zirconium oxide and less than 5% by weight of chromium oxide. The molten glass is fiberized to obtain the mineral wool.

The invention relates to the field of the melting of glass. It relates more specifically to the electric melting of glass intended to be converted into mineral wool by fiberizing.

Glass compositions capable of being fiberized by an internal centrifugation process, that is to say one which resorts to spinners rotating at high speed and pierced by orifices, are known from the application WO 00/17117. These compositions are characterized in particular by a high alumina content (from 16% to 27%) and a high content of alkali metal oxides (from 10% to 17%), the silica content ranging from 39% to 55%. The mineral wools thus produced exhibit thermal properties (in particular of resistance to fire and to high temperatures) which are markedly improved with respect to the glass wool of standard composition. This type of glass can be melted in flame or electric furnaces.

Electric furnaces comprise a tank comprising sidewalls and a bottom which are formed of blocks made of refractory materials and have electrodes which introduce an electric current into the molten glass. The latter, which is capable of conducting electricity, is heated by the Joule effect, the mass of molten glass constituting the resistance.

During the melting of the abovementioned type of glass, the tank of the electric furnaces is generally formed of refractory blocks based on chromium oxide or comprising a high content of chromium oxide (at least 10% by weight). Mention may be made, by way of examples, of the range of refractories sold under the Zirchrom® brand by Société Européenne des Produits Réfractaires (SEPR), which comprise, for example, 30% by weight of chromium oxide (Zirchrom® 30) or 83.5% of chromium oxide (Zirchrom® 85), or also the refractories sold under the references Monofrax K-3 (28% of chromium oxide) and Monofrax E (75% of chromium oxide) by RHI AG.

These refractories are employed as a result of their very high resistance to corrosion by the molten glass, including within the very high temperature ranges encountered during the electric melting of glasses of this type (up to 1800° C. and above in some parts of the furnace).

However, the inventors have observed that, under such production conditions, the orifices of the spinners are rapidly blocked off by devitrified glass, rendering the said spinners unusable and requiring their replacement.

It is an aim of the invention to overcome these disadvantages by providing a process for the manufacture of mineral wool comprising:
a melting stage which makes it possible to obtain a molten glass, the chemical composition of which comprises the following constituents, in a content by weight varying within the limits defined below:

| | |
|---|---|
| SiO₂ | 39-55% |
| Al₂O₃ | 16-27% |
| CaO | 3-35% |
| MgO | 0-5% |
| Na₂O + K₂O | 9-17% |
| Fe₂O₃ | 0-15% |
| B₂O₃ | 0-8% |

said melting stage being carried out by electric melting in a furnace comprising a tank made of refractory blocks and at least two electrodes immersed in the molten glass, at least one of said refractory blocks, in contact with said molten glass, being made of a material comprising at least 60% by weight of zirconium oxide and less than 5% by weight of chromium oxide, then
a stage of fiberizing said molten glass.

The term “electric melting” is understood to mean that the glass is melted by the Joule effect, by means of electrodes immersed in the glass bath, with the exclusion of any use of other heating means, such as flames.

The use, in at least a portion of the tank, of refractories having a high zirconia content and depleted in chromium oxide makes it possible to prevent any blockage of the orifices of the spinners. These refractories are referred to in the continuation of the description as “refractory materials having a high zirconia content”.

It turned out that, during the use of refractories based on chromium oxide, the gradual wear of the refractories, even to a very low extent, contaminates the molten glass with traces of chromium oxide, which traces have the effect, in this specific type of glass, of very strongly increasing its liquidus temperature. The latter may then rise above the temperature at the cold points of the spinners, of the order of 1160° C., bringing about devitrification of the glass in these coldest regions and thus blocking of the orifices.

For example, a glass comprising 43.3% of SiO₂, 21.4% of Al₂O₃, 5.9% of Fe₂O₃, 15.0% of CaO, 2.5% of MgO, 7.2% of Na₂O and 3.95% of K₂O has a liquidus temperature of 1150° C. This temperature changes to 1200° C. after addition of only 100 ppm of Cr₂O₃ and to 1240° C. after addition of 200 ppm of Cr₂O₃.

The zirconium oxide content of the materials having a high zirconia content is preferably at least 85%, in particular 90% and even 92%, in order to optimize the resistance of the material to corrosion by the molten glass. These are, as for all of the contents specified in the present text, contents by weight.

According to a less preferred embodiment, the zirconium oxide content can be between 60% and 70%. For example, refractories made of zircon (ZrSiO₄) may be concerned. Due to their poorer high-temperature resistance, these refractories will preferably be positioned at the bottom of the furnace.

The chromium oxide content is advantageously at most 1%, in particular 0.5%. It is even preferably zero or, in any case, in the form of traces.

The refractory material having a high zirconia content preferably comprises other oxides than ZrO₂ as the ZrO₂ crystals exhibit, due to changes in crystallographic phase, abnormal expansion characteristics capable of damaging the mechanical properties of the products made of zirconia. For this reason, the refractory material having a high zirconia content preferably comprises at least one “stabilizing” oxide chosen from SiO₂, Al₂O₃, B₂O₃, P₂O₅, Na₂O, CaO, MgO, SrO or BaO. The content of stabilizing oxide is typically within a range extending from 2% to 7%.

The blocks of the refractory material having a high zirconia content can, for example, be made of sintered ceramic or of refractory concrete or also be electrocast blocks (obtained by melting a mixture of starting materials in an arc furnace, followed by casting in a mold and by an annealing stage).

The blocks made of sintered ceramic are preferably made of zirconia stabilized using MgO. They preferably comprise at least 92% of ZrO₂, from 2% to 5% of MgO and from 1% to 3% of SiO₂. Mention may be made, as examples, of the refractories sold under the references Ziral 94 by Savoie Refractaires, Zettral 95 GR by RHI Glas GmbH or 3004 by Zircoa.

The refractory concretes preferably comprise from 2% to 4% of CaO and less than 1% of SiO₂, Al₂O₃ and TiO₂. They can, for example, be the products sold under the reference 0878 by Zircoa.

When it is in the form of electrocast blocks, the refractory material having a high zirconia content preferably comprises the oxides SiO₂, Na₂O and Al₂O₃ and exhibits in particular the following chemical composition:

| | |
|---|---|
| ZrO₂ | >92% |
| SiO₂ | 2-6.5% |
| Na₂O | 0.1-1.0% |
| Al₂O₃ | 0.4-1.2% |
| Fe₂O₃ + TiO₂ | <0.6% |
| P₂O₅ | <0.05% |

Mention may be made, by way of example, of the refractories sold under the reference ER 1195 by SEPR, which are blocks comprising approximately 94% of ZrO₂, from 4% to 5% of SiO₂, approximately 1% of Al₂O₃ and 0.3% of Na₂O.

The electrical resistivity of the refractive material having a high zirconia content is preferably at least 30 Ω·cm, indeed even 50 Ω·cm, at 1500° C. for a frequency of 100 Hz, in order to stabilize the electrical consumption during the melting of the glass and to prevent any short circuit in the refractories liable to cause damage to them.

The tank of the furnace generally comprises at least one casting opening located in the bottom of the tank or on a sidewall. In the latter case, the opening is generally located in the lower part of one of the walls.

The refractory blocks having a high zirconia content will preferably be positioned in the parts of the tank in contact with molten glass at very high temperature (for example above 1600° C. or 1700° C.) and/or subjected to strong convection currents.

Preferably, the refractory blocks forming the sidewalls of the tank in contact with the molten glass are made of a refractory material having a high zirconia content. This is because it is at the walls that the degree of corrosion of the refractories by the molten glass is among the highest, as a result of strong convection movements between the sidewalls and the electrodes.

It has been observed that at least a portion of the bottom is generally fairly weakly corroded and the choice of a refractory based on chromium oxide, which is both more durable and less expensive, is then particularly appreciable. For this reason, at least a portion and in particular all of the refractory blocks forming the bottom are advantageously made of a refractory material comprising at least 20% of chromium oxide.

Mention may be made, by way of examples, of the range of refractories which are sold under the Zirchrom® brand by the Société Européenne des Produits Réfractaires (SEPR), which comprise, for example, 30% by weight of chromium oxide (Zirchrom® 30) or 83.5% of chromium oxide (Zirchrom® 85), or also the refractories sold under the references Monofrax K-3 (28% of chromium oxide) and Monofrax E (75% of chromium oxide) by RHI AG.

When the casting opening is located on a sidewall of the tank, the refractory blocks forming the sidewalls of the tank in contact with the molten glass and the refractory blocks forming or surrounding the or each casting opening are preferably made of a refractory material having a high zirconia content, the refractory blocks forming the bottom preferably being made of a refractory material comprising at least 20% of chromium oxide. This is because, in such a configuration, the whole of the bottom is very weakly corroded.

When the casting opening is located in the bottom of the tank, at least a portion of the refractory blocks forming the bottom are preferably made of a refractory material having a high zirconia content. These are preferably the refractory blocks located close to the casting opening. The other refractory blocks forming the bottom are then preferably made of a refractory material comprising at least 20% of chromium oxide.

In addition to the tank, the furnace may or may not comprise a superstructure. The vitrifiable mixture is normally distributed uniformly over the surface of the glass bath using a mechanical device and thus forms a heat shield which limits the temperature above the glass bath, with the result that the presence of a superstructure is not always necessary.

The electrodes are immersed in the molten glass. They can be suspended, so as to dip into the glass bath via the top, be installed in the bottom or also be installed in the sidewalls of the tank. The first two options are generally preferred for large-size tanks in order to achieve the best possible distribution of the heating of the glass bath.

The electrodes are preferably made of molybdenum, indeed even optionally made of tin oxide. The electrode made of molybdenum passes through the bottom preferably via a water-cooled electrode holder made of steel.

The molten glass preferably exhibits a chemical composition comprising the following constituents, in a content by weight varying within the limits defined below:

| | |
|---|---|
| SiO₂ | 39-46%, preferably 40-45% |
| Al₂O₃ | 16-27%, preferably 18-26% |
| CaO | 6-20%, preferably 8-18% |
| MgO | 0.5-5%, preferably 0.5-3% |
| Na₂O + K₂O | 9-15%, preferably 10-13% |
| Fe₂O₃ | 1.5-15%, preferably 3-8% |
| B₂O₃ | 0-2%, preferably 0% |
| P₂O₅ | 0-3%, preferably 0-1% |
| TiO₂ | 0-2%, preferably 0.1-1%. |

The sum of the silica and alumina contents is preferably between 57% and 70%, in particular between 62% and 68%. The alumina content is preferably within a range extending from 20% to 25%, in particular from 21% to 24%.

The silica content is advantageously within a range extending from 40% to 44%.

The magnesia content is advantageously at most 3%, indeed even 2.5%, in order to minimize the liquidus temperature and thus the fiberizing temperature, so as to optimize the lifetime of the spinners.

The lime content is preferably within a range extending from 10% to 17%, in particular from 12% to 16%. The sum of the lime and magnesia contents is, for its part, preferably within a range extending from 14% to 20%, in particular from 15% to 18%. Preferably, the barium oxide content is at most 1%, in particular 0.5%. The strontium oxide content is, for its part, preferably at most 1%, indeed even 0.5% and even 0.1% or also zero.

The total content of alkali metal oxides (soda and potash) is preferably at most 13%, indeed even 12%. The Na₂O content is advantageously within a range extending from 4% to 9%, in particular from 5% to 8%, while the K₂O content is advantageously within a range extending from 3% to 6%.

Iron oxide has a positive effect on the nucleation and the growth of seeds at low temperature, and thus on the temperature behavior of the mineral wool, while not damaging the liquidus temperature thereof. Its total content (expressed in the Fe₂O₃ form, whether the iron is in ferric or ferrous form) is preferably at least 4%, and even 5%, and/or at most 7% or 6%. The redox, which corresponds to the ratio of the content of ferrous iron oxide to the total content of iron oxide, is generally within a range extending from 0.1 to 0.7. High redoxes confer, on the glass bath, a very strong absorption in the visible and the near infrared regions, decreasing, for this reason, the bottom temperature and increasing the convection movements in the furnace.

P₂O₅ can be used at contents of between 0% and 3%, in particular between 0.1% and 1.2%, in order to increase the biosolubility at neutral pH. Titanium oxide provides a very substantial effect on the nucleation at high and at low temperature of spinels in the vitreous matrix. A content of the order of 1% or less can prove to be advantageous. The content by weight of chromium oxide in the molten glass (before the fiberizing stage) is preferably at most 0.03%, in particular 0.02%, indeed even 0.01%, and even 0.005% (50 ppm). This is because it is apparent that, above these contents, the liquidus temperature of the glass increases excessively greatly, resulting in the blocking of the abovementioned orifices. In order to do this, the vitrifiable mixture employed will generally comprise chromium oxide only in the form of traces (a few tens of ppm).

Preferably, the total content of SiO₂, Al₂O₃, CaO, MgO, Na₂O, K₂O and Fe₂O₃ (total iron) is at least 90%, in particular 95% and even 97% or 98%.

These compositions are well suited to the process of fiberizing by internal centrifugation, with a viscosity at the temperature of 1400° C. generally of more than 40 poises, in particular of the order of 50 to 100 poises (1 poise=0.1 Pa·S).

These compositions exhibit high glass transition temperatures, in particular of greater than 600° C., in particular of greater than or equal to 650° C. Their upper annealing point is generally much greater than 600° C., in particular of the order of 670° C. or more, often of 700° C. or more.

The fiberizing stage is preferably carried out by internal centrifugation, for example according to the teaching of the application WO 93/02977. This is because the compositions are well suited to this method of fiberizing, their working ranges (corresponding to the difference between the temperature at which the decimal logarithm of the viscosity has a value of 2.5 and the liquidus temperature) generally being at least 50° C., indeed even 100° C. and even 150° C. The liquidus temperatures are not very high, generally at most 1200° C., indeed even 1150° C., and are compatible with the use of spinners. The internal centrifugation process employs spinners, also known as fiberizing dishes, rotating at high speed and pierced by orifices at their periphery. The molten glass is conveyed by gravity to the center of the spinner and, under the effect of the centrifugal force, is ejected through the orifices in order to form glass streams, which are drawn downward by jets of hot gases emitted by burners. The fibers obtained are bonded to one another using a sizing composition sprayed at their surface, before being received and formed in order to give various mineral wool products, such as rolls or panels.

Another subject matter of the invention is electric furnaces especially adapted to the implementation of the process according to the invention, in particular a furnace for the electric melting of the glass comprising a tank made of refractory blocks and at least two electrodes, said tank comprising sidewalls and a bottom, characterized in that the refractory blocks forming said sidewalls of the tank in contact with the molten glass are made of a material comprising at least 60% by weight of zirconium oxide and less than 5% by weight of chromium oxide and in that at least a portion, in particular all, of the refractory blocks forming said bottom are made of a material comprising at least 20% of chromium oxide.

Preferably, the furnace also comprises at least one casting opening, in particular located in the bottom of the tank or on a sidewall.

The preferred characteristics touched on above in connection with the process according to the invention are very obviously applicable to the furnace according to the invention and are not repeated here for reasons of conciseness.

Finally, a subject matter of the invention is a mineral wool obtained by the process according to the invention, in particular a mineral wool comprising glass fibers, the chemical composition of which comprises the following constituents, in a content by weight varying within the limits defined below:

| | |
|---|---|
| SiO₂ | 39-55% |
| Al₂O₃ | 16-27% |
| CaO | 3-35% |
| MgO | 0-5% |
| Na₂O + K₂O | 9-17% |
| Fe₂O₃ | 0-15% |
| B₂O₃ | 0-8% |
| ZrO₂ | 0.05-1%. |

The glass fibers preferably exhibit a chemical composition comprising the following constituents, in a content by weight varying within the limits defined below:

| | |
|---|---|
| SiO₂ | 39-46%, preferably 40-45% |
| Al₂O₃ | 16-27%, preferably 18-26% |
| CaO | 6-20%, preferably 8-18% |
| MgO | 0.5-5%, preferably 0.5-3% |
| Na₂O + K₂O | 9-15%, preferably 10-13% |
| Fe₂O₃ | 1.5-15%, preferably 3-8% |
| B₂O₃ | 0-2%, preferably 0% |
| P₂O₅ | 0-3%, preferably 0-1% |
| TiO₂ | 0-2%, preferably 0.1-1% |
| ZrO₂ | 0.05-1%, preferably 0.1-0.8%. |

The sum of the silica and alumina contents is preferably between 57% and 70%, in particular between 62% and 68%. The alumina content is preferably within a range extending from 20% to 25%, in particular from 21% to 24%.

The silica content is advantageously within a range extending from 40% to 44%.

The magnesia content is advantageously at most 3%, indeed even 2.5%, in order to minimize the liquidus temperature and thus the fiberizing temperature, so as to optimize the lifetime of the spinners.

The lime content is preferably within a range extending from 10% to 17%, in particular from 12% to 16%. The sum of the lime and magnesia contents is, for its part, preferably within a range extending from 14% to 20%, in particular from 15% to 18%. Preferably, the barium oxide content is at most 1%, in particular 0.5%. The strontium oxide content is, for its part, preferably at most 1%, indeed even 0.5% and even 0.1% or also zero.

The total content of alkali metal oxides (soda and potash) is preferably at most 13%, indeed even 12%. The Na₂O content is advantageously within a range extending from 4% to 9%, in particular from 5% to 8%, while the K₂O content is advantageously within a range extending from 3% to 6%.

Iron oxide has a positive effect on the nucleation and the growth of seeds at low temperature, and thus on the temperature behavior of the mineral wool, while not damaging the liquidus temperature thereof. Its total content (expressed in the Fe₂O₃ form, whether the iron is in ferric or ferrous form) is preferably at least 4%, and even 5%, and/or at most 7% or 6%.

P₂O₅ can be used at contents of between 0% and 3%, in particular between 0.1% and 1.2%, in order to increase the biosolubility at neutral pH. Titanium oxide provides a very substantial effect on the nucleation at high and at low temperature of spinels in the vitreous matrix. A content of the order of 1% or less can prove to be advantageous.

The content by weight of chromium oxide in the molten glass (before the fiberizing stage) is preferably at most 0.03%, in particular 0.02%, indeed even 0.01%, and even 0.005% (50 ppm). This is because it is apparent that, above these contents, the liquidus temperature of the glass increases excessively greatly, resulting in the blocking of the abovementioned orifices. In order to do this, the vitrifiable mixture employed will generally comprise chromium oxide only in the form of traces (a few tens of ppm).

The zirconia content is preferably within a range extending from 0.1% to 0.8%, in particular from 0.2% to 0.6%, indeed even from 0.3% to 0.5%. The presence of zirconia in the glass can improve the temperature and fire behavior of the fibers, even at a low content.

Preferably, the total content of SiO₂, Al₂O₃, CaO, MgO, Na₂O, K₂O and Fe₂O₃ (total iron) is at least 90%, in particular 95% and even 97% or 98%.

1. A process, comprising:
melting glass, thereby obtaining a molten glass, and then
fiberizing the molten glass, thereby obtaining a mineral wool,
wherein a chemical composition of the molten glass comprises, in a content by weight:

| | |
|---|---|
| SiO₂ | from 39 to 55% |
| Al₂O₃ | from 16 to 27% |
| CaO | from 3 to 35% |
| MgO | from 0 to 5% |
| Na₂O + K₂O | from 9 to 17% |
| Fe₂O₃ | from 0 to 15% |
| B₂O₃ | from 0 to 8% |

wherein the melting comprises electric melting in a furnace comprising a tank comprising refractory blocks and two electrodes immersed in the molten glass, and
wherein refractory blocks, in contact with the molten glass, comprise a material comprising at least 60% by weight of zirconium oxide and less than 5% by weight of chromium oxide.

2. The process as claimed in claim 1, wherein the chemical composition of the molten glass comprises, in a content by weight:

| | |
|---|---|
| SiO₂ | from 39 to 46% |
| Al₂O₃ | from 16 to 27% |
| CaO | from 6 to 20% |
| MgO | from 0.5 to 5% |
| Na₂O + K₂O | from 9 to 15% |
| Fe₂O₃ | from 1.5 to 15% |
| B₂O₃ | from 0 to 2% |
| P₂O₅ | from 0 to 3% |
| TiO₂ | from 0 to 2%. |

3. The process of claim 1, wherein refractory blocks in contact with the molten glass comprise a material comprising at least 85% by weight of zirconium oxide and less than 1% by weight of chromium oxide.

4. The process of claim 1, wherein refractory blocks forming sidewalls of the tank in contact with the molten glass comprise a material comprising at least 60% by weight of zirconium oxide and less than 5% by weight of chromium oxide.

5. The process of claim 1, wherein at least a portion of refractory blocks form a bottom of the tank and comprise a refractory material comprising at least 20% of chromium oxide.

6. The process of claim 1, wherein the blocks of the material comprising at least 60% by weight of zirconium oxide and less than 5% by weight of chromium oxide of comprise sintered ceramic or refractory concrete or are electrocast blocks.

7. The process of claim 1, wherein the tank of the furnace comprises a casting opening in a bottom of the tank.

8. The process of claim 7, wherein at least a portion of refractory blocks forming a bottom of the tank comprise a material comprising at least 60% by weight of zirconium oxide and less than 5% by weight of chromium oxide, and wherein other refractory blocks forming the bottom comprise a refractory material comprising at least 20% of chromium oxide.

9. The process as claimed in claim 1,
wherein a casting opening is on a sidewall of the tank,
refractory blocks forming sidewalls of the tank contact the molten glass,
refractory blocks forming or surrounding the casting opening comprise a material comprising at least 60% by weight of zirconium oxide and less than 5% by weight of chromium oxide,
refractory blocks forming a bottom of the tank comprise a refractory material comprising at least 20% of chromium oxide.

10. The process of claim 1, wherein the fiberizing comprises internal centrifugation.

11. The process of claim 1, wherein, before the fiberizing, the molten glass comprises a content by weight of chromium oxide of at most 0.03%.

12. A furnace, comprising a tank comprising refractory blocks and at least two electrodes,
wherein the tank comprises sidewalls and a bottom,
refractory blocks forming the sidewalls of the tank are adapted to contact with a molten glass and comprise a material comprising at least 60% by weight of zirconium oxide and less than 5% by weight of chromium oxide, and
at least a portion of refractory blocks forming the bottom comprise a material comprising at least 20% of chromium oxide.

13. The furnace of claim 12, comprising at least one casting opening in the bottom of the tank.

14. The furnace as claimed in the preceding claim of claim 12, wherein at least a portion of the refractory blocks forming the bottom comprise a material comprising at least 60% by weight of zirconium oxide and less than 5% by weight of chromium oxide, and wherein other refractory blocks forming the bottom comprise a refractory material comprising at least 20% of chromium oxide.

15. A mineral wool comprising glass fibers, the which comprise, by weight:

| | |
|---|---|
| SiO₂ | from 39 to 55% |
| Al₂O₃ | from 16 to 27% |
| CaO | from 3 to 35% |
| MgO | from 0 to 5% |
| Na₂O + K₂O | from 9 to 17% |
| Fe₂O₃ | from 0 to 15% |
| B₂O₃ | from 0 to 8% |
| ZrO₂ | from 0.05 to 1%. |
